(19) United States
(12) Patent Application Publication
(10) Pub. No.: US 2026/0281117 A1
(43) Pub. Date: Sep. 17, 2026

(54) Execution or Storage of Cloud Resources on Computing Devices Based on Physical Protection of the Computing Devices

(71) Applicant: Oracle International Corporation, Redwood Shores, CA (US)

(72) Inventors: William Nickolas Moran, Austin, TX (US); Zachary Gilburd, Seattle, WA (US)

(73) Assignee: Oracle International Corporation, Redwood Shores, CA (US)

(21) Appl. No.: 19/319,552

(22) Filed: Sep. 4, 2025

Related U.S. Application Data
(60) Provisional application No. 63/771,359, filed on Mar. 13, 2025.

(51) Int. Cl. H04L 9/40

(52) U.S. Cl. CPC H04L 63/10

(57) ABSTRACT

The present disclosure relates to methods and systems for protecting cloud resources. The methods and systems may use a virtual gatekeeper resource to enforce secure access controls to cloud resources for a list of privileged operations. The cloud resources and the virtual gatekeeper resource may be in different security domains within a cloud computing system and the cloud resources may be linked to the virtual gatekeeper resource. A request may be sent to perform a privileged operation on the cloud resource. Access may be provided to the virtual gatekeeper resource in response to approval of the request and the access to the virtual gatekeeper resource may be used to perform the privileged operation on the cloud resource.

### BENEFIT CLAIMS; RELATED APPLICATIONS; INCORPORATION BY REFERENCE

The following application is hereby incorporated by reference: U.S. Provisional Patent Application 63/771,359, filed Mar. 13, 2025.

### TECHNICAL FIELD

The present disclosure relates to controlling physical access to computing systems. More specifically, the disclosure is directed to securing cloud resources executed in cloud computing facilities.

### BACKGROUND

A datacenter is a facility that provides physical hardware infrastructure that houses computing hardware shared among multiple users such as customers of a cloud computing service. Because the infrastructure is shared, the facility allocates portions of hardware among the users. The users then store data or execute workloads on the allocated hardware using, for example, virtualization technologies, container orchestration systems, or bare-metal provisioning mechanisms. The workloads of some users involve confidential data that require protection from the other users. For example, one of the users may be a medical service provider that manages confidential patient data. To maintain confidentiality, the medical service provider may be required to process the data on devices that are isolated from other users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1A illustrates an example cloud resource architecture in accordance with one or more embodiments;

FIG. 1B illustrates an example cloud management system in accordance with one or more embodiments;

FIGS. 2A and 2B illustrate an example set of operations for protecting cloud resources in accordance with one or more embodiments;

FIG. 3 is a block diagram illustrating an example data structure storing a datacenter model in accordance with one or more embodiments;

FIG. 4 is a block diagram illustrating a model of a multilevel mapping between physical and logical elements in a datacenter in accordance with one or more embodiments;

FIG. 5A is a block diagram illustrating an example embodiment of a datacenter in accordance with one or more embodiments;

FIG. 5B is a block diagram illustrating an example data structure associating protection criteria with hierarchical levels of infrastructure in accordance with one or more embodiments;

FIGS. 6-9 are block diagrams illustrating patterns for implementing a cloud infrastructure as a service system in accordance with one or more embodiments; and

FIG. 10 is a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” is generally used to refer to a service that is made available by a cloud services provider (CSP) to users or customers on demand (e.g., via a subscription model) using systems and infrastructure (cloud infrastructure) provided by the CSP.

In most cases, the CSP is a third-party service that specializes in providing (e.g., offering, renting, selling) cloud services to customers. The servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services. In some instances, an entity might opt to deploy a private cloud, becoming its own provider of cloud services. In some instances, an entity may utilize both a private cloud and a public cloud provided by a third-party CSP, thereby forming a hybrid cloud.

There are several cloud service providers that offer various types of cloud services. There are various different types or models of cloud services including Software-as-a-Service (SaaS), Platform-as-a-Service (PaaS), Infrastructure-as-a-Service (IaaS), and others. In an IaaS model, the CSP provides infrastructure (referred to as “cloud services provider infrastructure” or “CSPI”) that can be used by customers to build their own customizable networks and deploy customer resources.

A customer can subscribe to one or more cloud services provided by a CSP. The customer can be any entity, and the like. When a customer subscribes to or registers for a service provided by a CSP, a tenancy, or an account, is created for that customer. The customer can then, via this account, access the subscribed-to one or more cloud resources associated with the account.

TABLE OF CONTENTS

| | |
|---|---|
| 1. | GENERAL OVERVIEW |
| 2. | PRACTICAL APPLICATIONS, ADVANTAGES & |
| | IMPROVEMENTS |
| 3. | CLOUD RESOURCE ARCHITECTURE |
| 4. | CLOUD MANAGEMENT SYSTEM |
| 5. | PROTECTING CLOUD RESOURCES |
| 6. | EXAMPLE EMBODIMENTS |
| 7. | EXAMPLES OF CLOUD INFRASTRUCTURE |
| 8. | COMPUTER SYSTEM |
| 9. | MISCELLANEOUS; EXTENSIONS |

### 1. GENERAL OVERVIEW

One or more embodiments control placement of a cloud resource for execution or storage on a computing device in a CPSI, such as a datacenter, based on the level of protection afforded to the computing device. Prior to provisioning the cloud resource to the computing device, the system determines the level of protection associated with the computing device. For example, the system identifies access control devices and surveillance devices associated with the computing device and evaluates configurations, current alerts or faults indicated by the devices. If the system determines that the level of physical protection meets protection criteria, the system initiates the provisioning of the cloud resource on the computing device. After provisioning, the system monitors and updates the level of protection. If the system subsequently detects an insufficient level of physical protection, then the system terminates the cloud resource.

One or more embodiments identify candidate physical computing devices for executing or storing a cloud resource. A system traverses the mappings between the candidate computing devices and protection mechanisms to identify a subset of the protection mechanisms associated with each of the candidate computing devices. The system then determines a level of protection corresponding to each of the candidate computing devices by the associated protection mechanisms. The system selects at least one of candidate computing devices to execute or store the cloud resource based on the level of protection of the selected computing device meeting protection criteria for hosting the cloud resource. In response to selection, the system initiates the execution or storage of the cloud resource on the computing device.

One or more embodiments generate a datacenter model that represents mappings between the physical locations, protection mechanisms, computing devices, and cloud resources residing in the datacenter. For example, the datacenter model may map a virtual machine (VM) instance to a hypervisor, the hypervisor to a computing device, the computing device to a physical location, and the physical location to protection mechanisms. Based on states of the protection mechanisms mapped to the computing devices by the datacenter model, the system determines if the level of protection of the computing device meets the level of protection for the cloud resource prior to initiating execution or storage of a cloud resource.

One or more embodiments described in this Specification and/or recited in the claims may not be included in this General Overview section.

### 2. PRACTICAL APPLICATIONS, ADVANTAGES & IMPROVEMENTS

One or more embodiments enhance the technical capabilities of systems that protect cloud resources executing within multi-tenant and multi-operator computing facilities, such as datacenters and other CSPI. Example systems prevent unauthorized access, enforce security policies, and maintain secure environments by associating cloud resources, computing devices, and protection mechanisms with the physical locations of the datacenter. Unlike conventional techniques that merely secure information using logical isolation or access control, example systems substantially increase the protection provided to a cloud resource by determining if a location of a computing device is physically protected prior to provisioning of the cloud resource at the computing device.

Additionally, one or more embodiments enhance protection of cloud resources within multi-tenant and multi-operator computing facilities by preventing access to the cloud resources by unauthorized users, such as other tenants and operators. The system selects a computing device for hosting a cloud resource based on the device's physical location and level of protection to ensure that only approved individuals or systems may interact with the cloud resource. For example, the system may receive a request to provision a VM at a location that a customer demands exclusive control during a designated time frame. Before provisioning the VM to a computing device, the system determines if physical locations housing the computing device meet protection criteria of the VM. Based on information obtained from protection mechanisms corresponding to a candidate computing device, the system may determine if any unauthorized individual is currently occupying the customer's exclusive area of control. If level of protection of the physical location is insufficient prior to initiating execution, or if the level of protection becomes insufficient during execution, the system prevents execution of the cloud resource.

### 3. CLOUD RESOURCE ARCHITECTURE

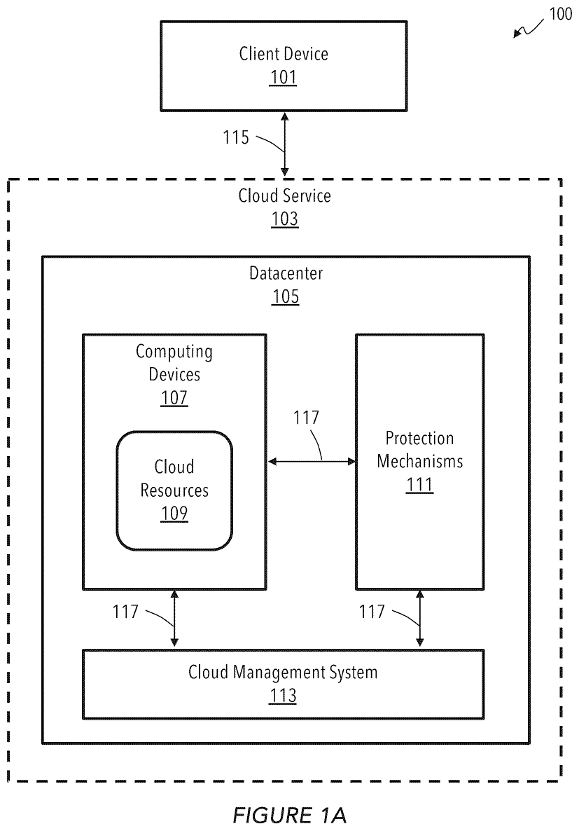

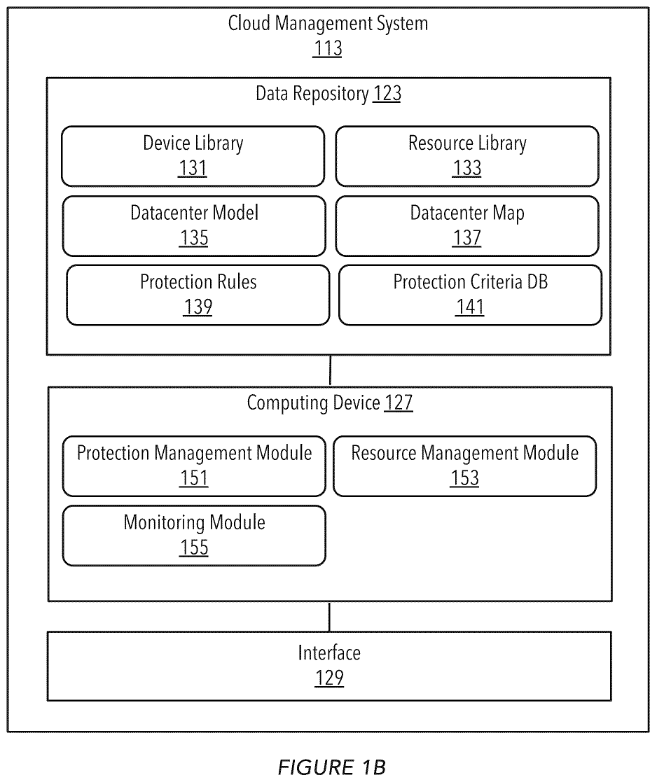

FIG. 1A illustrates an example cloud resource architecture 100 for executing cloud resources in protected locations accordance with one or more embodiments. As illustrated in FIG. 1A, the architecture 100 includes a client device 101, a cloud service 103, a datacenter 105, computing devices 107, cloud resources 109, protection mechanisms 111, and a cloud management system 113. As detailed herein, the client device 101 interacts with the cloud service 103 to provision and manage one or more of the cloud resources 109 on the computing devices 107 of the datacenter 105. The client device 101 is communicatively connected, directly or indirectly, with the computing devices 107, the protection mechanisms 111, and the cloud management system 113 via one or more communication links 115. In one or more embodiments, the architecture 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

The client device 101 is a computing system, such as a personal computer, workstation, server, mobile device, mobile phone, tablet device, and/or other processing device capable of implementing and/or executing software, applications, etc. The client device 101 may be operated by a user who may be an individual representing an organization or an enterprise that is a customer, operator, or provider of the cloud service 103. For example, the user may be an employee of a tenant that has subscribed or registered with the cloud service 103.

One or more embodiments of the client device 101 execute and display a computer-user interface allowing a user to access, perceive, and interact with hardware, software, and services of the cloud service 103 and the cloud management system 113. Depending on the implementation, the client device 101 may function as a workstation or a web-based interface, enabling remote access and interaction with the cloud service 103. For example, cloud data management system 113 may generate a console for the cloud management system 113 at the client device 101 that enables the user to configure, access, and manage the cloud resources 109 deployed in the datacenter 105 by a tenant. The console may be web-based user interface or client application that generates the graphic user interface (GUI) for a computer-user interface at the client device 101.

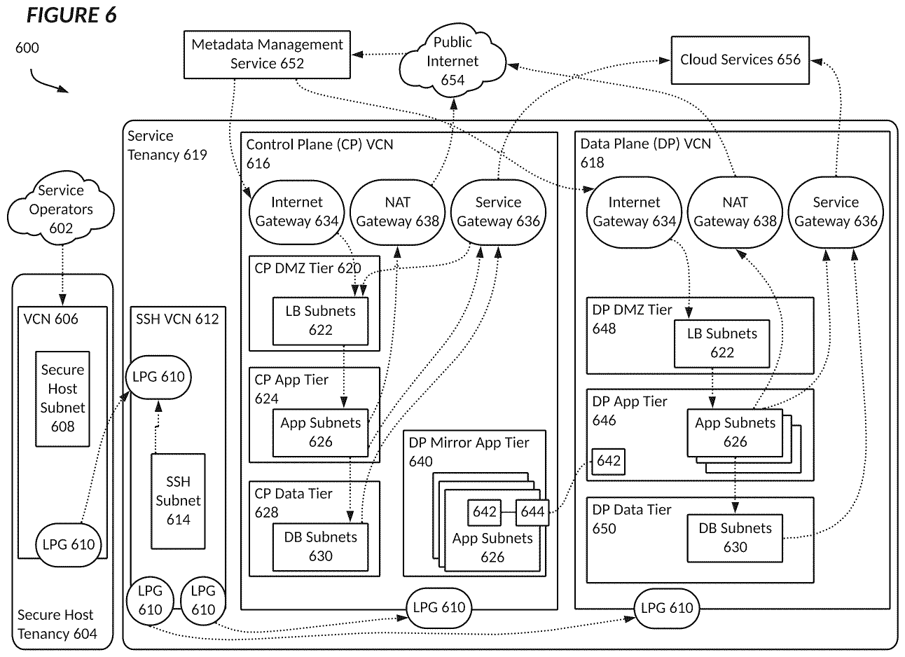

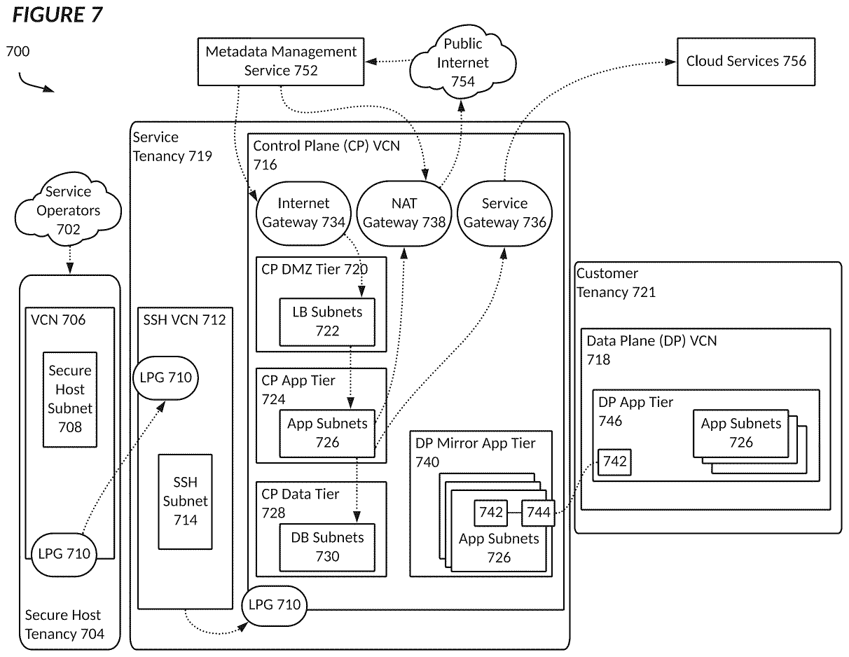

As detailed below regarding FIGS. 6-10, the cloud service 103 includes one or more services that are made available by a cloud services provider (CSP) to users or customers on demand using systems and infrastructure provided by the CSP. For example, the cloud service 103 may include components, such as database services and compute services, hosted on physical devices, such as servers, storage systems, and network devices within the datacenter 105.

The datacenter 105 is a component of CPSI that houses computational, storage, and networking services. The datacenter 105 includes physical computing devices 107 (e.g., servers, routers, switches, storage arrays) communicatively coupled via a network 117, such as a local area network (LAN) that supports virtualized computing environments, on-demand hardware services, or other distributed computing architectures. Additionally, the datacenter 105 may implement one or more resource orchestration layers, hypervisors, containerization frameworks, or other software-defined infrastructure to facilitate dynamic provisioning, scaling, or isolation of computing workloads.

The computing devices 107 are physical data processing devices or systems, including software and hardware, that provide computer resources (e.g., processing resources, memory resources, storage resources, network resources, etc.) for computing activities such as executing workloads. Example physical computing devices 107 include servers, racks of servers, personal computing devices, network active gear, network passive gear, storage devices, edge computing devices, and various other devices. Example servers include graphics processing unit (GPU) servers, central processing unit (CPU) servers, storage servers, and various other devices.

A cloud resource 109 is a unit of compute, storage, network, or service capacity available to users via the cloud service 103. A cloud resource 109 may correspond to a virtual or physical asset including any of the following: a VM, a container, a bare metal instance, storage units, virtual networks, firewalls, load balancers, and platform-level services (e.g., databases, analytics engines, machine learning (ML) endpoints). For example, a particular cloud resource 109 may be associated with a server that is mounted in a particular rack located in a particular aisle of a room within the datacenter 105.

The protection mechanisms 111 include physical devices that monitor and secure infrastructure of the datacenter 105. Example protection mechanisms 111 include access control devices, surveillance devices, environmental monitoring devices, and other such devices. Example access control devices systems include locking mechanisms, barriers, cages, security gates, mantrap entry systems, biometric authentication systems, radio frequency identification (RFID) and smart card readers, password-based authentication systems, and similar devices. Example surveillance devices include video cameras, motion sensors, radio-frequency sensors, imaging cameras, laser tripwire systems, alarms, audio surveillance systems, and similar devices. Example environment monitoring devices include fire sensors, smoke sensors, temperature sensors, water detection sensors, humidity sensors, and similar devices.

The cloud management system 113 includes hardware, software, or a combination thereof that initiates and terminates cloud resources 109 on the computing devices 107 based on the level of protection afforded by the protection mechanisms 111. The cloud management system 113 controls the protection mechanisms 111 to monitor physical access, detect environmental anomalies, and enforce access control policies. For example, based on state information obtained from the protection mechanisms 111, the cloud management system 113 determines if a particular computing device 107 affords a level of protection that satisfies protection criteria of a requested cloud resource 109. Responsive to determining that the level of protection satisfies the protection criteria, the cloud management system 113 initiates the execution or storage of the requested cloud resource on the computing device 107. Responsive to determining that the level of protection does not satisfy the protection criteria, the cloud management system 113 prevents or terminates execution or storage of the requested cloud resource on the computing device 107.

The communication links 115 include wired and/or wireless information communication channels, such as the Internet, an intranet, an Ethernet network, a wireline network, a wireless network, a mobile communications network, and/or another communication network. For example, the client device 101 may communicate with the cloud service 103 via the Internet by exchanging data packets through a Wi-Fi or cellular data network connection.

### 4. CLOUD MANAGEMENT SYSTEM

FIG. 1B illustrates an example of the cloud management system 113, including hardware and software that perform processes and functions described herein. In one or more embodiments, the cloud management system 113 includes more or fewer components than the components illustrated in FIG. 1B. The components illustrated in FIG. 1B can be local to or remote from each other. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the cloud management system 113 include a data repository 123, a computing device 127, and an interface 129. The data repository 123 includes any type of storage unit and/or device (e.g., a file system, database, collection of tables, or other storage mechanism) for storing data. Furthermore, the data repository 123 may include multiple different storage units and/or devices. The multiple different storage units and/or devices may or may not be of the same type or located at the same physical site. Furthermore, the data repository 123 can be implemented or executed on the same computing system as the resource management system 121. Additionally, or alternatively, the data repository 123 may be implemented or executed on a computing system separate from the resource management system 121. The data repository 123 can be communicatively coupled, wired and/or wirelessly, to the cloud management system 113 via a direct connection or via a network.

One or more embodiments of the data repository 123 stores a device library 131, a resource library 133, a datacenter model 135, a datacenter map 137, protection rules 139, and a protection criteria database 141. Information describing the device library 131, the resource library 133, the datacenter model 135, the datacenter map 137, the protection rules 139, and the criteria database 141 may be implemented across any of the components within the architecture 100. However, this information is illustrated within the data repository 123 for purposes of clarity and explanation.

The device library 131 is one or more logical data structures that store information of physical devices installed in the datacenter 105, including the computing devices 107 and the protection mechanisms 111. Information maintained by the device library 131 for individual devices may include one or more of the following: a device identifier, a physical location, an operational state, and a protection state. The information may also include or link to configuration files, event logs, surveillance logs, and historical data. The operational states indicate a device's health status or functional condition. Operational states include active, inactive, powered, initializing, paused, failed, and the like. For example, a temperature sensor in a server rack may output a signal indicating its operation state is active. The protection states indicate whether a fault, alert, or other protection event has been detected by a protection mechanism. The protection state may be obtained or derived from diagnostic signals, sensor outputs, control signals, or system logs generated by the protection mechanisms 111. The protection states may include a qualitative value (e.g., normal, warning, or faulted), a quantitative value (e.g., 0.00 to 1.00) indicating severity of the state, and metadata describing the event, fault, or alert. For example, the temperature sensor may output a signal indicating a binary value, such as “0” (e.g., pass) and “1” (e.g., fail), a qualitative value, such low, medium, high, and/or a quantitative value, such as “85 degrees” or “180 degrees.”

The resource library 133 is one or more logical data structures that store information identifying cloud resources 109 provisioned in the datacenter 105 or available for provisioning. The resource library 133 includes records that describe the characteristics, status, and associations of the cloud resources 109. Individual records in the resource library 133 may include metadata identifying the resource, the resource type, the hypervisors, the owner, or the tenant. Additionally, the resource library 133 can store computational parameters, protection parameters, current operational state (e.g., active, inactive, initializing, paused, suspended, failed, terminated), and an allocated computing device 107.

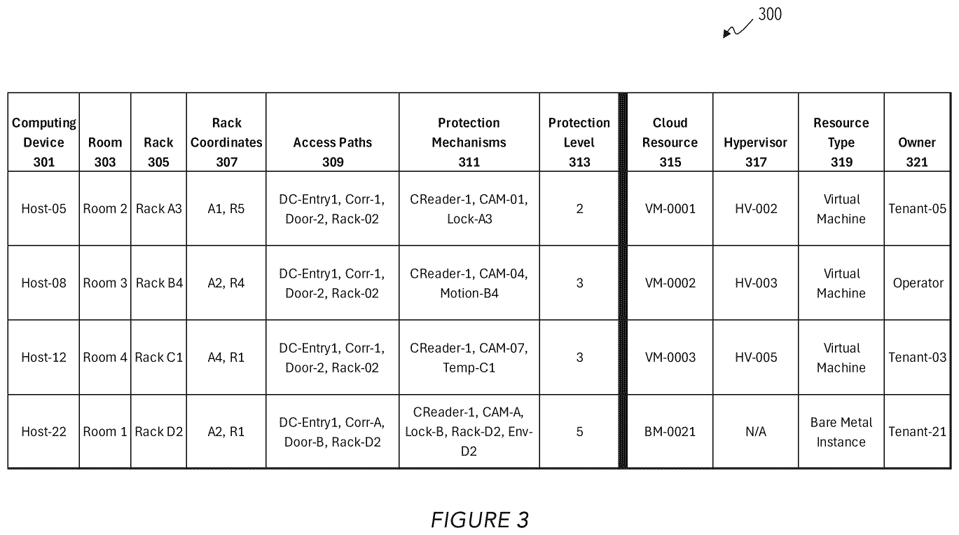

The datacenter model 135 includes one or more logical data structures that store information identifying relationships between the physical topology of the datacenter 105 and the physical locations of computing devices 107, cloud resources 109, and protection mechanisms 111 deployed within the datacenter. The datacenter model 135 may be implemented using structured tables, relational schemas, key-value associations, or other data representations of topological relationships. For example, FIG. 3 illustrates a data structure 300 including records of an example datacenter model 135.

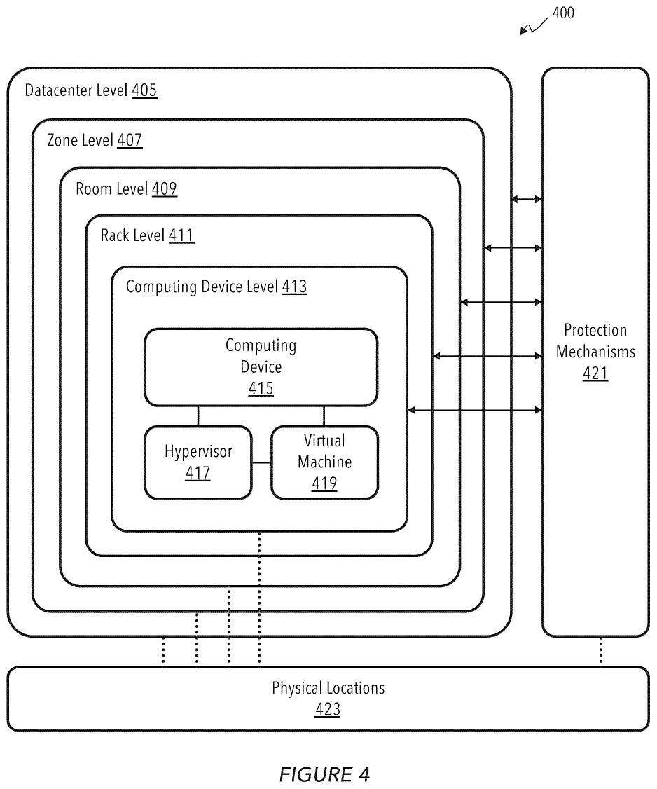

One or more embodiments of the datacenter model 135 represent mappings between the logical levels of the datacenter 105, physical devices, and physical locations of the device in the datacenter 105. For example, referring to the infrastructure model 400 illustrated in FIG. 4, the datacenter model 135 may associate a VM instance 419 with a hypervisor 417 and associate the hypervisor 417 with a corresponding physical computing device 415 in a computing device level 413. Additionally, the datacenter model 135 may associate the computing device 415 with a rack in a rack level 411, the rack with a room in a room level 409, the room with one or more zones in a zone level 407, and the zone with the datacenter facility in a datacenter level 405. Furthermore, each element in the hierarchy is linked to a physical location 423 and associated protection mechanisms 421.

In addition, the datacenter model 135 stores associations between computing devices 107 and corresponding protection mechanisms 111. The associations may be derived from the physical locations of the protection mechanisms relative to physical paths for accessing the computing devices 107. For instance, the datacenter model 135 may store an access path that a user may traverse to access a computing device 107 and a subset of protection mechanisms 111 corresponding to the access path. An example subset of protection mechanisms may include access control mechanisms at entry points, biometric or badge scanners in adjacent corridors, surveillance cameras monitoring interior rooms or aisles, and environmental or intrusion sensors installed near the rack.

Embodiments of the datacenter model 135 further associate individual computing devices 107 with a corresponding level of protection that represents the level of physical protection afforded to that device within the infrastructure of the datacenter 105 and the protection mechanisms 111. For example, the level of protection may be a discrete value in a predefined range (e.g., 1 to 5) representing a protection category (e.g., Level 1 to Level 5).

The datacenter map 137 includes one or more data structures that represent the datacenter's 105 physical layout. The layout may be represented as a graph, matrix, or coordinate-based structure that represents the arrangement of the physical infrastructure within the datacenter 105. For example, the datacenter map 137 includes information representing relationships among structural components, such as walls, partitions, and equipment rows. Additionally, the datacenter map 137 includes information encoding representations of physical features, including doors, corridors, rooms, aisles, rows, and rack locations. Furthermore, the datacenter map 137 includes information encoding directional movement constraints for routes of travel between locations within the datacenter 105. Some embodiments store pre-established travel routes representing access paths between entry points and rack locations.

The protection rules 139 include logic and/or models that determine protection criteria for the cloud resources 109 to be provisioned on computing devices within the datacenter 105. The protection rules 139 translate protection parameters associated with provisioning request into a level of protection having corresponding protection criteria.

For example, the protection rules may classify the protection parameters into one of a predefined set of categories, such as Protection Level 1 through Protection Level 5, where the individual levels correspond to progressively more stringent protection criteria. Some protection rules 139 may be correspond to particular customers or tenants. For example, a set of protection rules may incorporate user policies, service agreements, operator constraints, and regulations to derive protection criteria and/or a level of protection corresponding to a particular customer.

The protection rules 139 may use a deterministic model or an ML model to determine the target level of protection. The deterministic model may apply predefined rules, decision trees, or logic to map input parameters to specific protection criteria or levels. The ML model may be trained using historical provisioning data and protection outcomes to predict the appropriate level of protection based on features extracted from the request and associated contextual information.

The protection criteria database 141 include includes one or more data structures storing protection criteria. Protection criteria includes requirements for physical access control, surveillance levels, environmental constraints, and network isolation. Some embodiments associate predefined sets of protection criteria with levels of protection or categories. For example, a set of protection criteria for a particular computing resource may require full physical and logical isolation, tenant-dedicated cage, tenant-dedicated room, separate room entry, authorized personnel list, logged access, real-time environmental monitoring, and logged, 24-hour audio and video surveillance, facial recognition, and automated alerts.

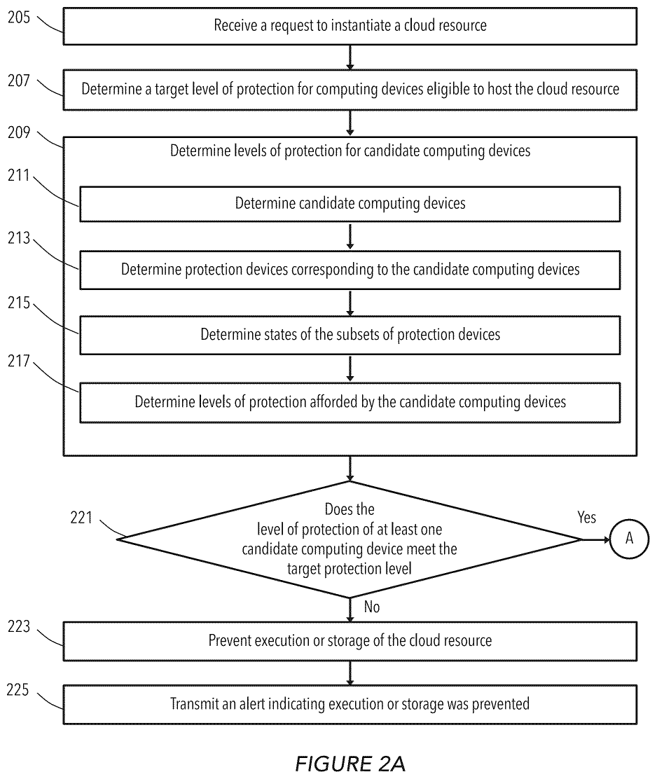

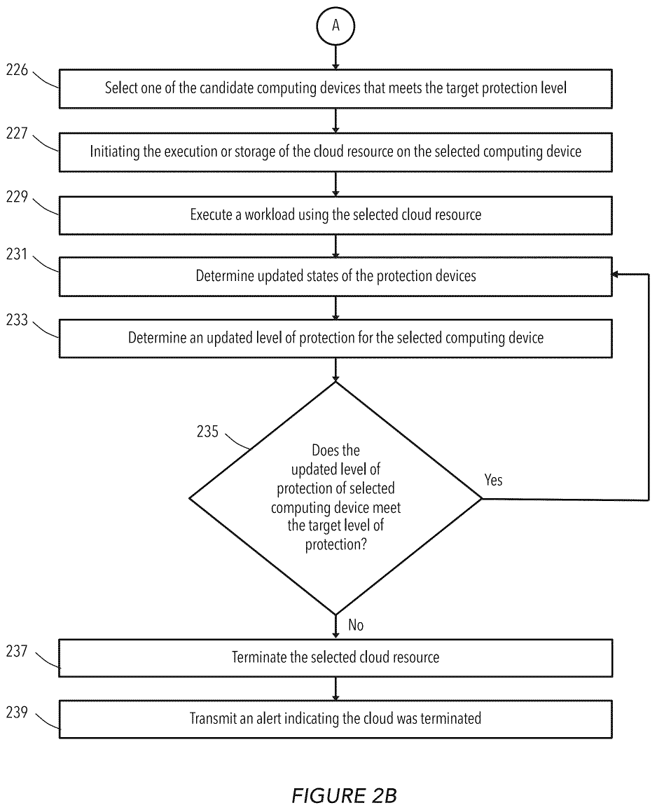

One or more embodiments of the computing device 127 include hardware and/or software configured to perform operations described herein. Example operations are described below with reference to FIGS. 2A and 2B. The computing device 127 executes non-transitory computer-readable program instructions, such as an operating system and application programs, that are stored in memory devices and/or a storage system. Additionally, the computing device 127 executes program instructions of a protection management module 151, a resource management module 153, and a monitoring module 155.

The protection management module 151 manages the protection mechanisms 111 within the datacenter 105. Managing the protection mechanisms 111 includes installing and configuring the protection mechanisms 111. Installation may include registering a protection mechanism 111 with the device library 131 and/or the datacenter model 135. Configuring includes establishing access policies, operational schedules, and threshold parameters for a protection mechanism 111 to trigger alerts, events, or faults. The installed access policies may, for example, define the individuals or entities authorized to access specific locations of the datacenter 105 and schedules for the access. The access policies may be defined based on user identity, assigned role, security clearance level, time of day, environmental conditions, incident response states, or other contextual parameters.

The resource management module 153 controls the selection and provisioning of the cloud resources 109. As detailed below, the resource management module 153 selects one or more of the computing devices 107 for instantiating or placing one or more of the cloud resources 109 based on the current level of protection afforded to the computing device 107. Additionally, the resource management module 153 controls the provisioning of a cloud resource 109 based on other criteria, such as hardware requirements, resource utilization, service agreements, and policy constraints.

The monitoring module 155 collects, aggregates, and processes operational data from computing, storage, and network infrastructure components. The monitoring module 155 may interact with one or more agents, collectors, and backend services to continuously or periodically receive status information from the computing devices 107, protection mechanisms 111, and other infrastructure of the datacenter 105. The status information may include health metrics, event logs, and alerts. The monitoring module 155 logs the status information in the device library 131 and the resource library 133 as time-indexed records. Additionally, the monitoring module 155 generates and maintains the datacenter model 135. Generating the datacenter model 135 includes obtaining device information from the device library 131, resource library 133, the protection management module 151, and/or the resource management module 153 to populate records the datacenter model 135 such as illustrated in FIG. 3.

In one or more embodiments, the interface 129 includes hardware and/or software configured to facilitate communications between a user and the cloud management system 113. The interface 129 renders user interface elements and receives input via user interface elements. Examples of interfaces include a GUI, a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, different components of interface 129 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the interface 129 is specified in one or more other languages, such as Java, C, or C++.

### 5. PROTECTING CLOUD RESOURCES

FIGS. 2A and 2B illustrate an example set of operations for protecting cloud resources in accordance with one or more embodiments. One or more operations illustrated in FIGS. 2A and 2B may be modified, rearranged, or omitted. Accordingly, the particular sequence of operations illustrated in FIGS. 2A and 2B should not be construed as limiting the scope of one or more embodiments.

A system receives a request to instantiate a cloud resource (Operation 205). The system may receive the request from a user via an interface presented at a client computing device. The request may include information identifying the requestor (e.g., a cloud service tenant or operator), the requested cloud resource, and parameters for provisioning the cloud resource. The parameters include computing parameters, such as compute, memory, storage, input/output, and network requirements. The parameters also include protection parameters, such location, isolation, access control, constraints, and monitoring requirements. For example, the protection parameters may specify that the host computing device be accessible through access-controlled routes, be monitored by active surveillance equipment, and reside within a locked rack accessible by a predefined set of authorized users during a particular time frame.

The system determines a target level of protection for computing devices that are eligible to host the cloud resource (Operation 207). One or more embodiments determine the target level of protection by applying the information and parameters contained in the request as inputs to a set of protection rules that determine a set of protection criteria. In some embodiments, the protection rules categorize the request into one of several levels of protection, wherein each level corresponds to set of protection criteria. For example, the system may classify requests into one of five levels of protection: Level 1, Level 2, Level 3, Level 4, and Level 5. Protection Level 1 may correspond to minimal security requirements and non-sensitive information. Protection Level 1 may specify no dedicated physical isolation, permit multi-tenants, allow access by general operations personnel, impose only baseline environmental monitoring (e.g., temperature), and not require continuous surveillance. For example, the system may assign Level 1 to requests for public-facing web applications that do not process confidential information. Protection Level 2 may specify one or more of the following: access-controlled room based on user-roles, expanded environmental monitoring (e.g., temperature and smoke), and manual or triggered surveillance. Protection Level 3 may specify one or more of the following: access controlled room with a role-limited user access list; logical isolation of the computing device; environmental sensors (e.g., temperature, smoke, and humidity); continuous video surveillance; and surveillance logs that are retained for a specified minimum duration. Protection Level 4 may specify one or more of the following: physically partitioned rooms or enclosures accessible only to named individuals with biometric authentication; logical isolation using tenant-dedicated hardware or bare-metal provisioning; access logs with timestamps and user identification; expanded environmental monitoring (e.g., temperature, humidity, smoke, cooling system state with automated fault detection); and continuous video surveillance requirements, including redundant high-resolution video capture with tamper-evident storage. Protection Level 5 may specify one or more of the following: full physical and logical isolation in tenant-dedicated cages or rooms with separate ingress points and monitored physical entry limited whitelist of personnel approved by the tenant and logged in a secure access registry; real-time environmental monitoring and analysis, leak detection, particulate monitoring, and fire suppression readiness; and 24-hour audio and video surveillance with facial recognition and automated alerts.

In one example, the system defines the levels of protection using a set of attribute-value pairs that associate respective protection criteria with corresponding values. Additionally, different sets of attribute-value pairs may be associated with respective hierarchical levels of the datacenter infrastructure, such as a datacenter level, a zone level, a room level, a rack level, and a computing device level. For instance, at Protection Level 4, the protection criteria applicable at the rack level may include attribute-value pairs, such as rack-sharing: no; rack-access: keypad; access-logging: yes; temperature-sensor: yes; humidity-sensor: yes; smoke-sensor: yes; cooling-sensor: yes; and fault-detection: yes. Some levels of protection may include sets of attribute-value pairs corresponding to each hierarchical level of the infrastructure, while other levels of protection may only include attribute-value pairs corresponding to a few or a single level (e.g., the room level and the rack level).

It is understood that the system is not limited to the example levels of protection and protection criteria described above. One or more embodiments may include additional protection categories or levels, including more granular categories and criteria corresponding to, for example, different tenants, regulations, or infrastructures. The system may define additional levels of protection above or below the five examples previously described or may implement sub-levels within each level. For instance, Protection Level 3 may be subdivided into Levels 3A, 3B, and 3C, each reflecting incremental enhancements in monitoring, access auditing, or system redundancy. These additional levels, or sub-levels, may be predefined or may be specified dynamically by an operator or a tenant. Additionally, some embodiments of the system generate a dashboard or other user interface that allows a user to manually create and edit the level of protection and criteria.

The system determines levels of protection for candidate computing devices (Operation 209). To determine the candidate levels of protection, the system evaluates the types, states, and locations of protection mechanisms that correspond to computing devices eligible and available to provision the cloud resource. Determining the candidate levels of protection includes determining candidate computing devices available to host the requested cloud resource (Operation 211). The system identifies the candidate computing devices based on parameters of the request. Identifying the candidate computing devices may include determining a set of computing devices in the datacenter that satisfy the computational parameters of the request. For example, the system may identify candidate computing devices that meet or exceed parameters for CPU, memory, storage, input/output capacity, and/or network capacity.

Determining the levels of protection of the candidate computing devices may further include determining protection mechanisms corresponding to the identified candidate computing devices (Operation 213). One or more embodiments identify a subset of protection mechanisms associated with each candidate computing device by referencing a datacenter model. As described above, the datacenter model stores associations between the computing devices and corresponding subsets of the protection mechanisms located along respective access paths of the computing device. Alternatively, the system identifies a subset of protection mechanisms associated with each candidate computing device by identifying access paths using an electronic map that encodes constraints for travel routes between locations on the datacenter. Using the map, the system determines access paths from entry points to the computing device and identifies the protection mechanisms located in proximity to the identified access paths.

Additionally, determining the levels of protection includes determining states of the protection mechanisms in the subsets (Operation 215). Determining the states of the protection mechanisms includes receiving or polling for information from the protection mechanisms to obtain events, alerts, and faults generated by protection mechanisms. For example, a badge scanner located at a secure entrance may generate an event when a user accesses or exits a room. In another example, a power sensor may generate a fault when power draw of a candidate computing device exceeds a threshold specified by the protection criteria. Each protection mechanism's state, including alerts or faults, may be logged along with contextual metadata. The logged states may be indexed by time and include a device identifier, a location, and a severity. For example, a logged alert may indicate the identity of individuals present in the room along with entry and exit times, related access control events, or recent workload deployments associated with nearby infrastructure.

The system determines the respective levels of protection afforded to the candidate computing devices (Operation 217). Determining the levels of protection may include categorizing the candidate computing devices into respective levels of protection (e.g., Level 1 through Level 5) by comparing the protection mechanism states to predefined protection criteria associated with each level of protection. Some embodiments categorize each candidate computing device into a level of protection by comparing the types, locations, and states of protection mechanisms with the protection criteria defined for each level of protection. One or more embodiments associate the levels of protection with a respective sets of attribute-value pairs that specify required conditions for particular types of protection mechanisms. Each candidate computing device may likewise be associated with a set of attribute-value pairs that describe the protection mechanisms and their states. The system may compare attribute-values pairs of the level of protection with the corresponding attribute-values pairs of corresponding to the candidate computing devices. For example, at Protection Level 4, the protection criteria at the rack level may include attribute-value pairs such as: rack-sharing: no; rack-access: keypad; access-logging: yes; temperature-sensor: yes; humidity-sensor: yes; smoke-sensor: yes; cooling-sensor: yes; and fault-detection: yes. The system may determine if the subset of protection mechanisms associated with the candidate computing device at the rack level satisfies these attribute-value pairs. The system may repeat this evaluation for each hierarchical level applicable to the levels of protection being evaluated. If the candidate computing device satisfies the protection criteria across the applicable hierarchical levels, and if the corresponding protection mechanisms are operational, then the candidate computing device may be classified into Protection Level 4. If one or more of the protection criteria are not satisfied, the candidate computing device may instead be classified into a lower level of protection such as Protection Level 3.

Alternatively, in some embodiments, the system may apply a protection model configured to evaluate and assign a level of protection to each of the candidate computing devices. The protection model may be implemented using a deterministic model or a trained ML model that receives the types, locations, and attribute-value pairs of a subset of protection mechanisms as an input and generates a corresponding level of protection classification as an output. For example, the system may classify a candidate computing device located in an unlocked rack within an access-controlled room as meeting Protection Level 3. In another example, the system may classify a computing device located in a room with access control that would ordinarily satisfy Protection Level 2 but that currently includes a door lock in a failed state as satisfying Protection Level 1.

The system determines if the level of protection of at least one candidate computing device satisfies the target level of protection of the request (Operation 221). The system evaluates the levels of protection of the candidate computing devices against the target level of protection associated with the request. If the level of protection of the candidate computing devices do not satisfy the target level of protection, then the system prevents execution or storage of the cloud resource (Operation 223). For example, the system may determine that the datacenter currently lacks any computing devices that are available, eligible, and meet criteria of Protection Level 5. Preventing execution or storage may include declining to allocate any of the candidate computing devices to host the requested cloud resource. Additionally, in combination with preventing execution, the system may transmit an alert indicating that execution or storage of the workload was prevented due to insufficient protection score (Operation 225). The alert may include contextual information identifying the failed protection criteria, the protection scores of the evaluated candidate devices, the identity of the requesting tenant or user, and the time and location of the attempted execution. The alert may be transmitted to a system administrator, tenant interface, compliance auditing service, or automated remediation system. For example, if a workload designated for a high-assurance environment cannot be placed due to a disabled biometric scanner along the access path to the most eligible host, the system may issue an alert for display by a dashboard of a dashboard presented by a user interface.

As indicated by off-page connector “A,” if the protection score of a candidate computing devices satisfies the protection criteria, then the system selects one of the qualifying candidate computing devices (Operation 226). Upon determining that a particular computing device meets or exceeds the protection score threshold, the system selects the candidate computing device for executing or storing the cloud resource. If multiple candidate devices satisfy the threshold, the system may select one of the candidates based on the respective computational parameters and/or protection parameters of the devices. For example, the system may calculate weighted rankings of the qualifying computing devices based on, for example, computational capacity and resources, level of protection, and cost. Based on the rankings, the system may select one or the qualifying candidate computing devices associated with the lowest computational resources, cost, and level of protection that satisfy the parameters in relation to the qualifying candidate computing devices.

The system initiates the execution or storage of the cloud resource in the selected computing device (Operation 227). Initiating includes assigning the selected computing device to the request and instantiates the cloud resource. Additionally, the system may store or update metadata of the assigned cloud resource in the resource library and/or datacenter model. For example, as illustrated in FIG. 3, the system may associate an identifier of the selected computing device with identifiers of the cloud resource, a hypervisor, a resource type, and the owner. The system executes a workload using the selected cloud resource (Operation 229). Execution may include launching user-defined processes, initiating application-level services, or running batch or stream processing jobs according to the execution parameters specified in the workload request.

The system determines updated states of the protection mechanisms (Operation 231). The system continues to monitor and record current states of the protection mechanism, including the subset of protection mechanisms corresponding to the selected computing device along with contextual metadata such as the identity of individuals present in the affected area, related access control events, or recent workload deployments associated with nearby infrastructure

The system determines an updated level of protection for the selected computing device (Operation 233). The system determines the level of protection of the selected computing devices based on the updated states of the protection mechanisms that corresponding to the selected computing device. The system determines if the updated level of protection of the selected computing device satisfies the target level of protection of the request (Operation 235). If the updated level of protection of the selected computing device satisfies the protection criteria, then the system iteratively returns to updating the states of the protection mechanisms and determining updated level of protection. If the updated level of protection of the selected computing device does not satisfy the protection criteria, the system terminates or transfers execution of the selected cloud resource (Operation 237) For example, the system may determine that the selected computing device no longer meets criteria of Protection Level 5 because an unauthorized user entered the room housing the computing device. In response, the system may stop the cloud resource executing on the computing device. Additionally, some embodiments may programmatically transfer the cloud resource to another qualified computing device.

The system may also transmit an alert indicating that execution of the workload was terminated (Operation 239). The alert may include contextual information identifying the failed protection criteria and the updated protection level of the selected computing device. For example, the system may issue an alert for display by the dashboard indicating that an unauthorized person entered the room housing the cloud resource, the time of the event, and identity the person. In response to the alert, the user may manually terminate the computing resource and trigger the system to programmatically transfer the cloud resource to another qualified computing device.

### 6. EXAMPLE EMBODIMENTS

Detailed examples are described below for purposes of clarity. Components and/or operations described below should be understood as one specific example that may not be applicable to certain embodiments. Accordingly, components and/or operations described below should not be construed as limiting the scope of any of the claims.

FIG. 3 is a block diagram illustrating an example data structure 300 storing records of a datacenter model in accordance with one or more embodiments. The records of the example datacenter model identify relationships between computing devices, physical locations, access paths, protection mechanisms, and levels of protection of the computing devices. In this example, columns 301-313 of the data structure model 300 associate computing devices with respective rooms, racks, rack coordinates, access paths, protection mechanisms, and levels of protection. The computing device column 301 identifies a hardware entity within the datacenter that is capable of hosting one or more provisioned cloud resources, such as a physical server or storage system. The room column 303 identifies the particular physical room or other enclosed area housing the computing device, such as a tenant-dedicated space, a shared room, or an isolated zone within the datacenter. The rack coordinated column 307 identifies the position of the rack containing the computing device using a coordinate scheme that may include aisle identifiers, row numbers, and rack identifiers within a room. The access paths column 309 identifies one or more ordered sequences of physical and logical checkpoints, such as datacenter entrances, corridors, doors, access control systems, and secure racks, that authorized users physically traverse to access the computing device. The protection mechanisms column 311 identifies the set of physical and logical security mechanisms associated with the computing devices. The level of protection column 313 identifies a quantitative or categorical security classification assigned to the computing device based on its surrounding physical environment, applicable access control mechanisms, surveillance coverage, isolation guarantees, and compliance with regulatory or contractual protection requirements.

For example, the datacenter model indicates that computing device Host-22 is located in Room 1 within Rack D2 having coordinates A2, R1 (e.g., Aisle 2 and Row 1). The datacenter model further indicates that Host-22 is associated with an access path in the datacenter that includes DC-Entry1, Corridor-A, Door-B, and Rack-D2, representing a physical route from the primary datacenter entrance through Corridor A, through access-controlled Door B, and to secured Rack D2. Additionally, the datacenter model identifies Host-22 as being associated with protection mechanisms C-Reader-1, CAM-A, Door-Lock-B, Rack-Lock-D2, and Env-D2 that respectively correspond to card reader 1, surveillance camera A, electronic door lock B, rack-specific locking mechanism D2, and environmental monitoring systems designated Env-D2. Furthermore, the datacenter model classifies Host-22 as satisfying the requirements for Protection Level 5 that indicates, for example, the host is physically isolated, access-controlled, continuously monitored, and located within a tenant-dedicated room and rack.

Additionally, upon provisioning a cloud resource to a host computing device, the datacenter model is updated to associate the cloud resource with the corresponding host computing device. The columns 315 through 321 of the example datacenter model record such associations by linking computing devices to cloud resources, virtualization infrastructure, resource classifications, and corresponding tenants or owners. The cloud resource column 315 identifies a provisioned logical resource instance hosted on the computing device, such as a VM, container, bare metal server instance, or any other form of cloud-exposed compute resource. The hypervisor column 317 identifies the virtualization layer or management software that is responsible for creating, controlling, or monitoring the cloud resource hosted on the computing device. The resource type column 319 identifies the operational classification of the cloud resource instance, such as “VM,” “container,” “bare metal,” “GPU-enabled instance,” or other predefined types associated with specific service level agreements or usage models. The owner column 321 identifies the account, tenant, organization, or other entity to that the cloud resource instance has been provisioned. For example, the datacenter model indicates that Host-22 is associated with a cloud resource identified as BM-21. The resource BM-21 is classified as a bare metal instance and is recorded as being owned by tenant-21.

FIG. 4 is a block diagram illustrating a datacenter a model 400 of a multilevel mapping between hierarchical physical levels of a datacenter in accordance with one or more embodiments. As previously described, the datacenter model 400 associates the hierarchical levels 405-413 with protection mechanisms 421 and respective physical locations 423. In the present example, the levels include a datacenter level 405, a zone level 407, a room level 409, a rack level 411, and a computing device level 413. The computing device level 413 may associate a VM instance 419 with one or more of the protection mechanisms 413 at respective locations. Additionally, the infrastructure model 400 associates the computing device 415 with a rack at the rack level 411. Moreover, the infrastructure model 400 associates the rack with a room of the data center at the room level 409, a corridor leading to the room at the zone level 407, and an entry door to the datacenter at the datacenter level 405. Each the topological elements at each the levels 405, 407, 409, 411, and 413 may be associated with one or more of the protection mechanisms at a respective physical location 423 in the corresponding level.

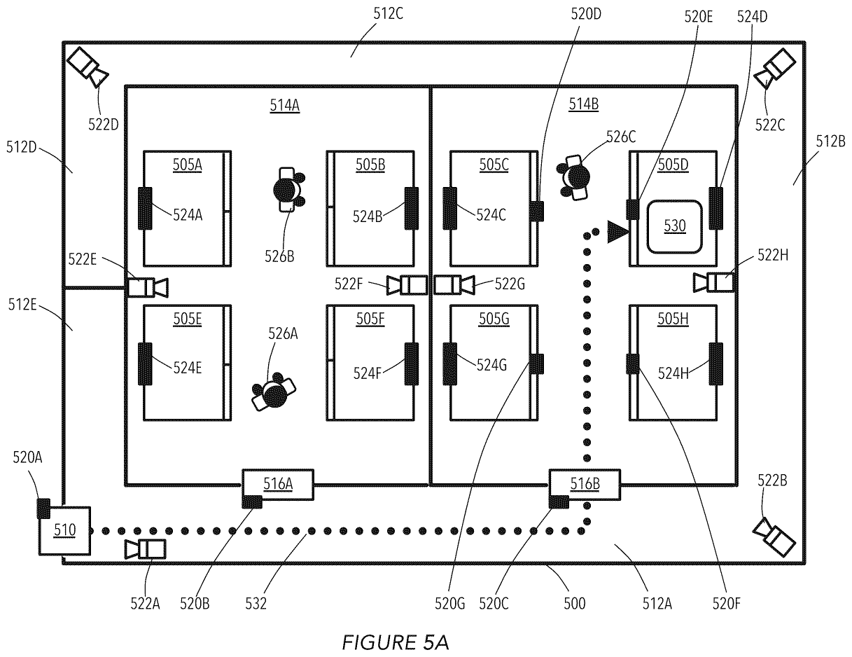

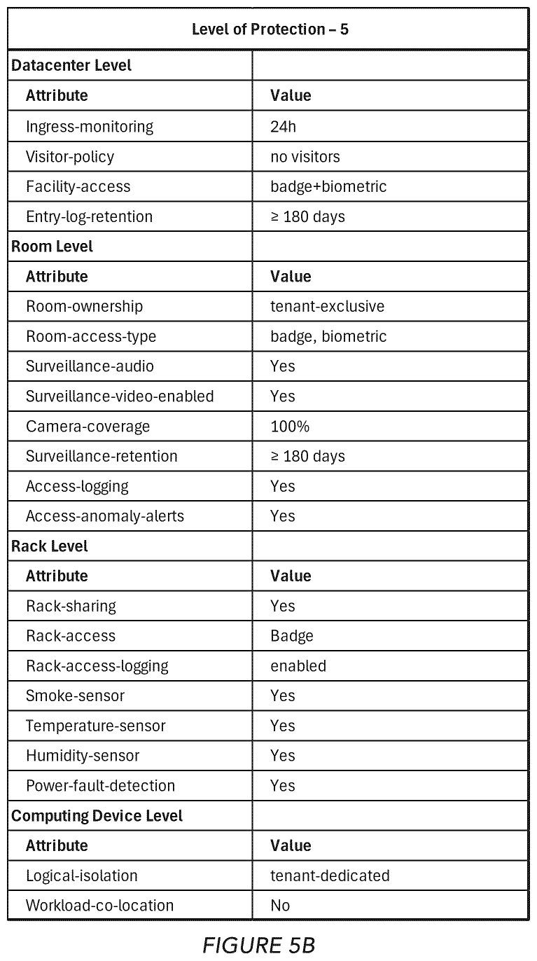

FIG. 5A illustrates an infrastructure of an example datacenter 500 in accordance with one or more embodiments. In this example, a cloud service receives a request from a tenant to provision a VM for the deployment of a new workload in the datacenter 500. The request includes a set of parameters specifying requirements for the cloud resource. These parameters include computational parameters for a processor architecture, memory size, storage capacity, input/output capacity, and network configuration. Additionally, the request includes protection parameters for access control, surveillance coverage, environmental monitoring conditions, and data protection requirements.

The system determines a target level of protection for the request based on the protection parameters as well as relevant policies, service agreements, regulations, and other constraints not explicitly specified in the request. As detailed above, the system may apply a set of protection rules or an ML model trained to classify the request into one of a set of predefined levels of protection. In this example, the protection parameters indicate that the VM is intended to process extremely sensitive information and execute on a tenant-exclusive computing device. Additionally, the protection parameters specify that the tenant requires exclusive physical access during the hours of 9:00 a.m. to 6:00 μm. Based on the received parameters, service agreements, datacenter policies, and regulations associated with the tenant, the system maps the request to Protection Level 5. In this example, the target level of protection corresponds to a set of protection criteria representing full physical and logical isolation of the computing resource in a tenant-dedicated room with independent entry, access limited to a predefined set of authorized personnel, and continuous audiovisual and environmental surveillance throughout the protected area. FIG. 5B illustrates an example set attribute-value pairs representing target protection criteria generated for the request.

Additionally, the system evaluates the parameters to determine a set of candidate computing devices that are eligible for provisioning the requested VM. The system identifies these candidate computing devices housed in racks 505A-505H by applying the computational requirements of the request as filters across a library of available computing devices. The registry may include metadata describing the resource capacity, performance metrics, location, and operational status of the computing devices within the datacenter 500.

For each candidate computing device, the system identifies and analyzes a corresponding subset of protection mechanisms associated with that computing device. The datacenter 500 may include various protection mechanisms located at different hierarchal levels of the datacenter infrastructure such as illustrated in FIG. 4. As illustrated in FIG. 5A, the infrastructure of the example datacenter 500 includes a primary entrance 510, corridors 512A-512E, rooms 514A and 514B, and doors 516A and 516B. The protection mechanisms may include access control devices 520A-520G, surveillance devices 522A-522H, and environmental sensors 524A-524H. Additionally, users 526A, 526B, and 526C wearing RFID badges may reside in the datacenter 500. In the present example, the primary entrance 510 and corridors 512A-512E are categorized as being in the datacenter level 405; the rooms 514A and 514B and doors 516A and 516B are categorized as being in the room level 409; and the racks 505A-505H are categorized as being in the rack level 411. As such, the access control device 520A and surveillance devices 522A-522D are associated with the datacenter level 405. The access control devices 520B and 520C, surveillance devices 522E-522H, and badges of the users 526A-526C are associated with the room level 409. The access control devices 520D-520F and environmental sensors 524A-524H are associated with the rack level 411.

In the present example, server 530 is one of the candidate computing devices for available and eligible to host the requested VM. As illustrated in FIG. 5A, the server 530 is housed in rack 505D within room 514B. The system determines a subset of the protection mechanisms associated with the server 530 based on an access path 532 corresponding to location of the server 530. As previously described, the system may retrieve information describing the subset of protection mechanisms for the server 530 from a datacenter model such as illustrated in FIG. 3. Alternatively, the system may use mapping techniques to determine the subset of protection mechanisms in proximity to an access path 532 for the server 530.

As illustrated in FIG. 5A, the subset of protection mechanisms for the server 530 includes access control device 520A, cameras 522A and 522B, access control device 520C, access control device 520E, and environmental sensors 524D. The system maps the physical locations of these protection mechanisms across hierarchical containment levels of the datacenter 500, such as datacenter level 405, room level 409, rack level 411, and device level 413, and evaluates if the protection configuration at each level satisfies the attribute-value pairs defined for Protection Level 5. Accordingly, at the room level 409, the system may verify that protection is enforced by access control device 520C and 520E with biometric validation, that entry logs are enabled and actively monitored, and that cameras 522G and 522H provide coverage with real-time recording and retention capabilities. At the rack level 411, the system may verify that a candidate server resides rack 505D configured for exclusive access by an authorized user 526C of the requesting tenant, that the rack 505D is equipped with access control device 520E (e.g., key-coded locks) and that environmental sensors 524D include operational sensors for temperature, humidity, smoke, and power.

Furthermore, the system may determine if states of the protection mechanisms associated with server 530 satisfy the protection criteria. In this example, the system determines that each of protection mechanisms 520A, 520E, 522A, 522B, 522G, 522H, 526B, 524D, and 526C is operating and not indicating any protection fault, alerts, or events. For example, the system may determine that logs generated by access control device 520C and cameras 522G and 522H only indicate the authorized user 526C currently in room 514B. Additionally, the system may determine that the badge of user 526C is authorized and no badges of unauthorized users, such as users 526A and 526B, are located in the room 514B. Moreover, the system may determine that the access control devices 520C and 520E are locked and configured solely for access by specific users. Furthermore, the system may determine that the environmental sensors 524D are operational and reporting acceptable ranges.

If the system determines that the server 530, in conjunction with the associated protection mechanisms and their states, satisfies the criteria for the hierarchical levels associated with Protection Level 5, then the system may select the server 530 to provision the requested VM. Once selected, the system initiates the instantiation of the VM according to the parameters of the request. During the operation of the VM on the server 530, the system monitors the states of the protection mechanism and updates the level of protection of the hosting server 530. If the level of protection falls below Level 5, then the system terminates the execution of the VM. In response to the termination, the system may programmatically transfer the VM to a different server meeting the target level of protection.

### 7. EXAMPLES OF CLOUD INFRASTRUCTURE

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create VMs, install operating systems (OSs) on each VM, deploy middleware, such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>. [REGION] [.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c4” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service VMs (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more VMs. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed are required to be first set up. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 implemented in the SSH VCN 612. The SSH VCN 612 can include an SSH subnet 614, and the SSH VCN 612 can be communicatively coupled to a control plane VCN 616 via the LPG 610 implemented in the control plane VCN 616. Also, the SSH VCN 612 can be communicatively coupled to a data plane VCN 618 via an LPG 610. The control plane VCN 616 and the data plane VCN 618 can be implemented in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 640 (e.g., frontend DB subnet(s) and/or backend DB subnet(s)). The LB subnet(s) 622 in the control plane DMZ tier 620 can be communicatively coupled to the app subnet(s) 626 in the control plane app tier 624 and an Internet gateway 644 that can be implemented in the control plane VCN 616. The app subnet(s) 626 can be communicatively coupled to the DB subnet(s) 640 implemented in the control plane data tier 628 and a service gateway 646 and a network address translation (NAT) gateway 648. The control plane VCN 616 can include the service gateway 646 and the NAT gateway 648.

The control plane VCN 616 can include a data plane mirror app tier 640 that can include app subnet(s) 626. The app subnet(s) 626 implemented in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be implemented in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 644 of the data plane VCN 618. The app subnet(s) 626 can be communicatively coupled to the service gateway 646 of the data plane VCN 618 and the NAT gateway 648 of the data plane VCN 618. The data plane data tier 650 can also include the DB subnet(s) 640 that can be communicatively coupled to the app subnet(s) 626 of the data plane app tier 646.

The Internet gateway 644 of the control plane VCN 616 and of the data plane VCN 618 can be communicatively coupled to a metadata management service 652 that can be communicatively coupled to public Internet 654. Public Internet 654 can be communicatively coupled to the NAT gateway 648 of the control plane VCN 616 and of the data plane VCN 618. The service gateway 646 of the control plane VCN 616 and of the data plane VCN 618 can be communicatively couple to cloud services 656.

In some examples, the service gateway 646 of the control plane VCN 616 or of the data plane VCN 618 can make application programming interface (API) calls to cloud services 656 without going through public Internet 654. The API calls to cloud services 656 from the service gateway 646 can be one-way; the service gateway 646 can make API calls to cloud services 656, and cloud services 656 can send requested data to the service gateway 646. However, cloud services 656 may not initiate API calls to the service gateway 646.

In some examples, the secure host tenancy 604 can be directly connected to the service tenancy 619. The service tenancy 619 may otherwise be isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision resources. Resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be implemented in the data plane mirror app tier 640 and the data plane app tier 646.

In some examples, users or customers, of the system, can make requests, for example create, read, update, or delete (CRUD) operations, through public Internet 654 that can communicate the requests to the metadata management service 652. The metadata management service 652 can communicate the request to the control plane VCN 616 through the Internet gateway 644. The request can be received by the LB subnet(s) 622 implemented in the control plane DMZ tier 620. The LB subnet(s) 622 may determine that the request is valid, and in response, the LB subnet(s) 622 can transmit the request to app subnet(s) 626 implemented in the control plane app tier 624. If the request is validated and requires a call to public Internet 654, the call to public Internet 654 may be transmitted to the NAT gateway 648 that can make the call to public Internet 654. Metadata to be stored by the request can be stored in the DB subnet(s) 640.

In some examples, the data plane mirror app tier 640 can facilitate direct communication between the control plane VCN 616 and the data plane VCN 618. For example, changes, updates, or other suitable modifications to a configuration may need to be applied to the resources implemented in the data plane VCN 618. Via a VNIC 642, the control plane VCN 616 can directly communicate with, and can thereby execute the changes, updates, or other suitable modifications to configuration to, resources implemented in the data plane VCN 618.

In some embodiments, the control plane VCN 616 and the data plane VCN 618 can be implemented in the service tenancy 619. In this case, the user, or the customer, of the system may not own or operate either the control plane VCN 616 or the data plane VCN 618. Instead, the IaaS provider may own or operate the control plane VCN 616 and the data plane VCN 618. The control plane VCN 616 and the data plane VCN 618 may be implemented in the service tenancy 619. This embodiment can enable isolation of networks that may prevent users or customers from interacting with other users', or other customers', resources. Also, this embodiment may allow users, or customers, of the system to store databases privately without needing to rely on public Internet 654, that may not have a sufficient level of threat protection, for storage.

In other embodiments, the LB subnet(s) 622 implemented in the control plane VCN 616 can be configured to receive a signal from the service gateway 646. In this embodiment, the control plane VCN 616 and the data plane VCN 618 may be configured to be called by a customer of the IaaS provider without calling public Internet 654. Customers of the IaaS provider may need this embodiment since database(s) that the customers use may be controlled by the IaaS provider and may be stored on the service tenancy 619. The service tenancy 619 may be isolated from public Internet 654.

FIG. 2 is a block diagram 200 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 710 implemented in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 implemented in the control plane VCN 716. The control plane VCN 716 can be implemented in a service tenancy 719 (e.g., the service tenancy 619 of FIG. 6), and the data plane VCN 718 (e.g., the data plane VCN 618 of FIG. 6) can be implemented in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), and a control plane data tier 728 (e.g., the control plane data tier 628 of FIG. 6) that can include database (DB) subnet(s) 740 (e.g., similar to DB subnet(s) 640 of FIG. 6). The LB subnet(s) 722 implemented in the control plane DMZ tier 720 can be communicatively coupled to the app subnet(s) 726 implemented in the control plane app tier 724 and an Internet gateway 744 (e.g., the Internet gateway 644 of FIG. 6) that can be implemented in the control plane VCN 716. The app subnet(s) 726 can be communicatively coupled to the DB subnet(s) 740 implemented in the control plane data tier 728 and a service gateway 746 (e.g., the service gateway 646 of FIG. 6) and a network address translation (NAT) gateway 748 (e.g., the NAT gateway 648 of FIG. 6). The control plane VCN 716 can include the service gateway 746 and the NAT gateway 748.

The control plane VCN 716 can include a data plane mirror app tier 740 (e.g., the data plane mirror app tier 640 of FIG. 6) that can include app subnet(s) 726. The app subnet(s) 726 implemented in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be implemented in a data plane app tier 746 (e.g., the data plane app tier 646 of FIG. 6). The compute instance 744 can facilitate this communication via the VNIC 742 implemented in the data plane mirror app tier 740 and the VNIC 742 implemented in the data plane app tier 746.

The Internet gateway 744 implemented in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 748 implemented in the control plane VCN 716. The service gateway 746 implemented in the control plane VCN 716 can be communicatively couple to cloud services 756 (e.g., cloud services 656 of FIG. 6).

In some examples, the data plane VCN 718 can be implemented in the customer tenancy 721. In this case, the IaaS provider may provide the control plane VCN 716 for a customer, and the IaaS provider may, for a customer, set up a unique, compute instance 744 that is implemented in the service tenancy 719. A compute instance 744 may allow communication between the control plane VCN 716 implemented in the service tenancy 719 and the data plane VCN 718 that is implemented in the customer tenancy 721. The compute instance 744 may allow resources provisioned in the control plane VCN 716 that is implemented in the service tenancy 719 to be deployed or otherwise used in the data plane VCN 718 that is implemented in the customer tenancy 721.

In other examples, the customer of the IaaS provider may have databases that are implemented in the customer tenancy 721. In this example, the control plane VCN 716 can include the data plane mirror app tier 740 that can include app subnet(s) 726. The data plane mirror app tier 740 can be implemented in the control plane VCN 716, but the data plane mirror app tier 740 may not be implemented in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity implemented in the control plane VCN 716. The customer may need to deploy or otherwise use resources in the data plane VCN 718 that are provisioned in the control plane VCN 716, and the data plane mirror app tier 740 can facilitate the deployment or other usage of resources of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, implemented in the customer tenancy 721, can help isolate the data plane VCN 718 from other customers and from public Internet 754.

In some embodiments, cloud services 756 can be called by the service gateway 746 to access services that may not exist on public Internet 754, on the control plane VCN 716, or on the data plane VCN 718. The connection between cloud services 756 and the control plane VCN 716 or the data plane VCN 718 may not be active or continuous. Cloud services 756 may exist on a different network owned or operated by the IaaS provider. Cloud services 756 may be configured to receive calls from the service gateway 746 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 1” may be located in Region 1 and in “Region 2.” If a call to Deployment 1 is made by the service gateway 746 implemented in the control plane VCN 716 located in Region 1, the call may be transmitted to Deployment 1 in Region 1. In this example, the control plane VCN 716, or Deployment 1 in Region 1, may not be communicatively coupled to, or otherwise in communication with, Deployment 1 in Region 2.

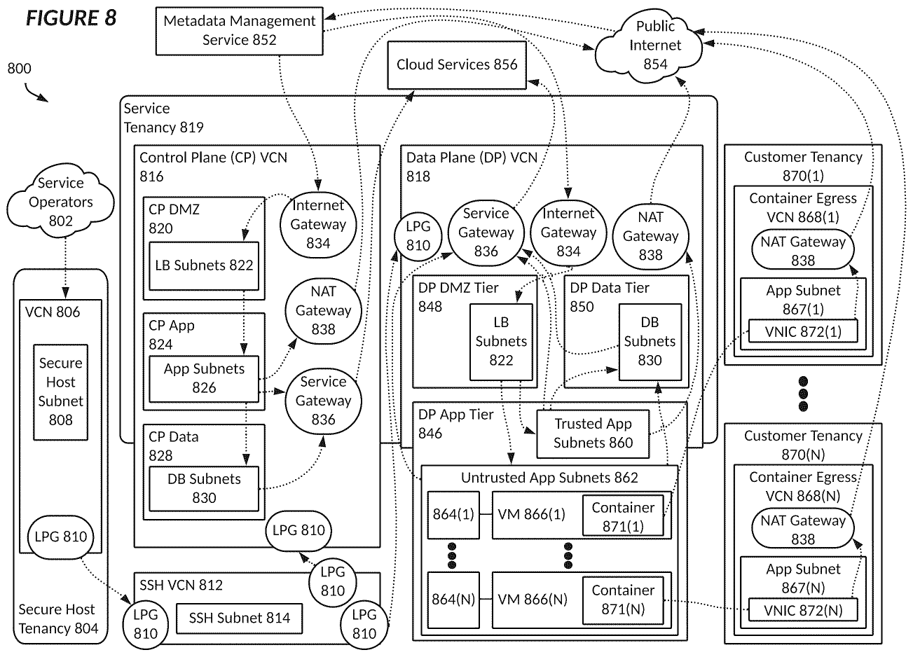

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 implemented in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 implemented in the control plane VCN 816 and to a data plane VCN 818 (e.g., the data plane VCN 618 of FIG. 6) via an LPG 810 implemented in the data plane VCN 818. The control plane VCN 816 and the data plane VCN 818 can be implemented in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), and a control plane data tier 828 (e.g., the control plane data tier 628 of FIG. 6) that can include DB subnet(s) 840. The LB subnet(s) 822 implemented in the control plane DMZ tier 820 can be communicatively coupled to the app subnet(s) 826 implemented in the control plane app tier 824 and to an Internet gateway 844 (e.g., the Internet gateway 644 of FIG. 6) that can be implemented in the control plane VCN 816, and the app subnet(s) 826 can be communicatively coupled to the DB subnet(s) 840 implemented in the control plane data tier 828 and to a service gateway 846 (e.g., the service gateway of FIG. 6) and a network address translation (NAT) gateway 848 (e.g., the NAT gateway 648 of FIG. 6). The control plane VCN 816 can include the service gateway 846 and the NAT gateway 848.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860, untrusted app subnet(s) 862 of the data plane app tier 846, and the Internet gateway 844 implemented in the data plane VCN 818. The trusted app subnet(s) 860 can be communicatively coupled to the service gateway 846 implemented in the data plane VCN 818, the NAT gateway 848 implemented in the data plane VCN 818, and DB subnet(s) 840 implemented in the data plane data tier 850. The untrusted app subnet(s) 862 can be communicatively coupled to the service gateway 846 implemented in the data plane VCN 818 and DB subnet(s) 840 implemented in the data plane data tier 850. The data plane data tier 850 can include DB subnet(s) 840 that can be communicatively coupled to the service gateway 846 implemented in the data plane VCN 818.

The untrusted app subnet(s) 862 can include one or more primary VNICs 864(1)-(N) that can be communicatively coupled to tenant VMs 866(1)-(N). Tenant VMs 866(1)-(N) can be communicatively coupled to a respective app subnets 867(1)-(N) that can be implemented in respective container egress VCNs 868(1)-(N) that can be implemented in respective customer tenancies 870(1)-(N). Respective secondary VNICs 872(1)-(N) can facilitate communication between the untrusted app subnet(s) 862 implemented in the data plane VCN 818 and the app subnet implemented in the container egress VCNs 868(1)-(N). Container egress VCNs 868(1)-(N) can include a NAT gateway 848 that can be communicatively coupled to public Internet 854 (e.g., public Internet 654 of FIG. 6).

The Internet gateway 844 implemented in the control plane VCN 816 and implemented in the data plane VCN 818 can be communicatively coupled to a metadata management service 852 (e.g., the metadata management service 652 of FIG. 6) that can be communicatively coupled to public Internet 854. Public Internet 854 can be communicatively coupled to the NAT gateway 848 implemented in the control plane VCN 816 and implemented in the data plane VCN 818. The service gateway 846 implemented in the control plane VCN 816 and implemented in the data plane VCN 818 can be communicatively couple to cloud services 856.

In some embodiments, the data plane VCN 818 can be integrated with customer tenancies 870(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 846. Code to execute the function may be executed in the VMs 866(1)-(N), and the code may not be configured to execute anywhere else on the data plane VCN 818. VMs 866(1)-(N) may be connected to one customer tenancy 870(1). Respective containers 871(1)-(N) implemented in the VMs 866(1)-(N) may be configured to execute the code. In this case, there can be a dual isolation (e.g., the containers 871(1)-(N) executing code), where the containers 871(1)-(N) may be implemented in at least the VM 866(1)-(N) that are implemented in the untrusted app subnet(s) 862) that may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completing execution of the code, the IaaS provider may terminate or otherwise dispose of the containers 871(1)-(N).

In some embodiments, the trusted app subnet(s) 860 may execute code that may be owned or operated by the IaaS provider. In this embodiment, the trusted app subnet(s) 860 may be communicatively coupled to the DB subnet(s) 840 and be configured to execute CRUD operations in the DB subnet(s) 840. The untrusted app subnet(s) 862 may be communicatively coupled to the DB subnet(s) 840, but in this embodiment, the untrusted app subnet(s) may be configured to execute read operations in the DB subnet(s) 840. The containers 871(1)-(N) that can be implemented in the VM 866(1)-(N) of a customer and that may execute code from the customer may not be communicatively coupled with the DB subnet(s) 840.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 846. For example, a call to cloud services 856 from the control plane VCN 816 can include a request for a service that can communicate with the data plane VCN 818.

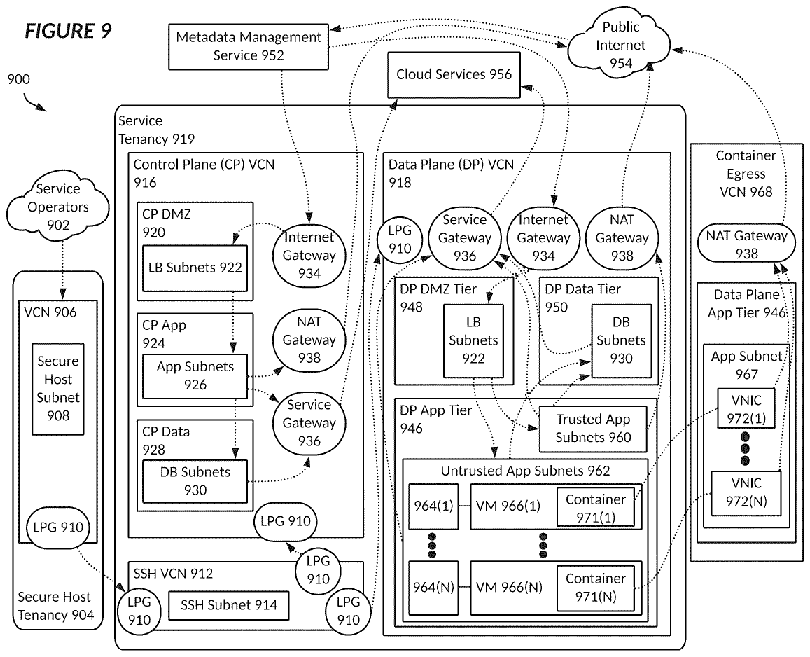

FIG. 9 is a block diagram illustrating another example pattern of an IaaS architecture 900 according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 implemented in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 implemented in the control plane VCN 916 and to a data plane VCN 918 (e.g., the data plane VCN 618 of FIG. 6) via an LPG 910 implemented in the data plane VCN 918. The control plane VCN 916 and the data plane VCN 918 can be implemented in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), and a control plane data tier 928 (e.g., the control plane data tier 628 of FIG. 6) that can include DB subnet(s) 940 (e.g., DB subnet(s) 840 of FIG. 8). The LB subnet(s) 922 implemented in the control plane DMZ tier 920 can be communicatively coupled to the app subnet(s) 926 implemented in the control plane app tier 924 and to an Internet gateway 944 (e.g., the Internet gateway 644 of FIG. 6) that can be implemented in the control plane VCN 916, and the app subnet(s) 926 can be communicatively coupled to the DB subnet(s) 940 implemented in the control plane data tier 928 and to a service gateway 946 (e.g., the service gateway of FIG. 6) and a network address translation (NAT) gateway 948 (e.g., the NAT gateway 648 of FIG. 6). The control plane VCN 916 can include the service gateway 946 and the NAT gateway 948.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 944 implemented in the data plane VCN 918. The trusted app subnet(s) 960 can be communicatively coupled to the service gateway 946 implemented in the data plane VCN 918, the NAT gateway 948 implemented in the data plane VCN 918, and DB subnet(s) 940 implemented in the data plane data tier 950. The untrusted app subnet(s) 962 can be communicatively coupled to the service gateway 946 implemented in the data plane VCN 918 and DB subnet(s) 940 implemented in the data plane data tier 950. The data plane data tier 950 can include DB subnet(s) 940 that can be communicatively coupled to the service gateway 946 implemented in the data plane VCN 918.

The untrusted app subnet(s) 962 can include primary VNICs 964(1)-(N) that can be communicatively coupled to tenant VMs 966(1)-(N) implemented within the untrusted app subnet(s) 962. Tenant VMs 966(1)-(N) can execute code in a respective container 967(1)-(N) and be communicatively coupled to an app subnet 967 that can be implemented in a data plane app tier 946 that can be implemented in a container egress VCN 968. Respective secondary VNICs 972(1)-(N) can facilitate communication between the untrusted app subnet(s) 962 implemented in the data plane VCN 918 and the app subnet 967 implemented in the container egress VCN 968. The container egress VCN 968 can include a NAT gateway 948 that can be communicatively coupled to public Internet 954 (e.g., public Internet 654 of FIG. 6).

The Internet gateway 944 implemented in the control plane VCN 916 and implemented in the data plane VCN 918 can be communicatively coupled to a metadata management service 952 (e.g., the metadata management service 652 of FIG. 6) that can be communicatively coupled to public Internet 954. Public Internet 954 can be communicatively coupled to the NAT gateway 948 implemented in the control plane VCN 916 and implemented in the data plane VCN 918. The service gateway 946 implemented in the control plane VCN 916 and implemented in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be needed for a customer of the IaaS provider if the IaaS provider cannot directly communicate with the customer (e.g., a disconnected region). The respective containers 971(1)-(N) that are implemented in the VMs 966(1)-(N) for a customer can be accessed in real-time by the customer. The containers 971(1)-(N) may be configured to make calls to respective secondary VNICs 972(1)-(N) implemented in app subnet(s) 967 of the data plane app tier 946 that can be implemented in the container egress VCN 968. The secondary VNICs 972(1)-(N) can transmit the calls to the NAT gateway 948 that may transmit the calls to public Internet 954. In this example, the containers 971(1)-(N) that can be accessed in real time by the customer can be isolated from the control plane VCN 916 and can be isolated from other entities implemented in the data plane VCN 918. The containers 971(1)-(N) may also be isolated from resources from other customers.

In other examples, the customer can use the containers 971(1)-(N) to call cloud services 956. In this example, the customer may execute code in the containers 971(1)-(N) that request a service from cloud services 956. The containers 971(1)-(N) can transmit this request to the secondary VNICs 972(1)-(N) that can transmit the request to the NAT gateway 948 that can transmit the request to public Internet 954. Public Internet 954 can transmit the request to LB subnet(s) 922 implemented in the control plane VCN 916 via the Internet gateway 944. In response to determining the request is valid, the LB subnet(s) can transmit the request to app subnet(s) 926 that can transmit the request to cloud services 956 via the service gateway 946.

It should be appreciated that IaaS architectures 600, 700, 800, and 900 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various VMs and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a VM, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a VM, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, VMs, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. COMPUTER SYSTEM

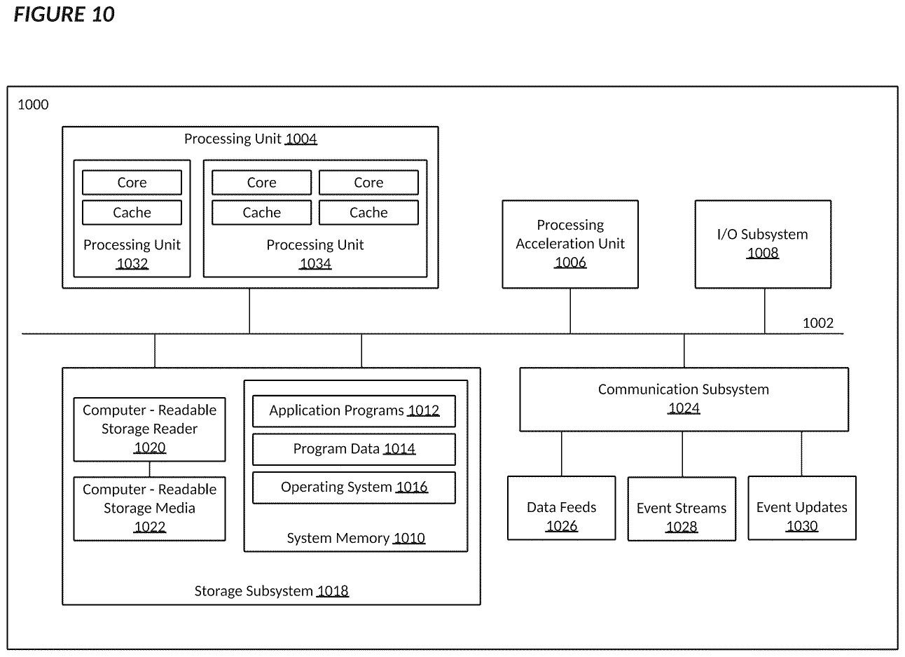

FIG. 10 illustrates an example computer system 1000. An embodiment of the disclosure may be implemented upon the computer system 1000. As shown in FIG. 10, computer system 1000 includes a processing unit 1004 that communicates with peripheral subsystems via a bus subsystem 1002. These peripheral subsystems may include a processing acceleration unit 1006, a I/O subsystem 1008, a storage subsystem 1018, and a communications subsystem 1024. Storage subsystem 1018 includes tangible computer-readable storage media 1022, computer-readable storage reader 1020 and a system memory 1010.

Bus subsystem 1002 provides a mechanism for letting the various components and subsystems of computer system 1000 to communicate with other components and subsystems as intended. Although bus subsystem 1002 is shown schematically as a single bus, alternative embodiments of the bus subsystem may utilize multiple buses. Bus subsystem 1002 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1486.1 standard.

Processing unit 1004 controls the operation of computer system 1000. Processing unit 1004 can be implemented as one or more integrated circuits (e.g., a conventional microprocessor or microcontroller). One or more processors may be implemented in processing unit 1004. These processors may include single core or multicore processors. In certain embodiments, processing unit 1004 may be implemented as one or more independent sub processing units 1042 and/or 1044 with single or multicore processors implemented in one or more processing units. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, the program code to be executed can be wholly or partially implemented in processing unit 1004 and/or in storage subsystem 1018. Through suitable programming, processing unit 1004 can provide various functionalities described above. Computer system 1000 may additionally include a processing acceleration unit 1006 that can include a digital signal processor (DSP), a special-purpose processor, and/or the like.

I/O subsystem 1008 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 460 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (4D) mice, joysticks or pointing sticks, gamepads and graphic tablets, and audio/visual devices, such as speakers, digital cameras, digital camcorders, portable media players, webcams, image scanners, fingerprint scanners, barcode reader 4D scanners, 4D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 1000 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 1000 may comprise a storage subsystem 1018 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 1004, provide the functionality described above. Storage subsystem 1018 may also provide a repository for storing data used in accordance with the present disclosure.

As depicted in the example in FIG. 10, storage subsystem 1018 can include various components, including a system memory 1010, computer-readable storage media 1022, and a computer readable storage media reader 1020. System memory 1010 may store program instructions, such as application programs 1012, that are loadable and executable by processing unit 1004. System memory 1010 may also store data, such as program data 1014, that is used during the execution of the instructions and/or data that is generated during the execution of the program instructions. Various programs may be loaded into system memory 1010 including, but not limited to, client applications, Web browsers, mid-tier applications, relational database management systems (RDBMS), VMs, containers, etc.

System memory 1010 may also store an operating system 1016. Examples of operating system 1016 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 1000 executes one or more VMs, the VMs along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 1010 may include a basic input/output system (BIOS) including basic routines that help to transfer information between elements within computer system 1000 such as during start-up.

Computer-readable storage media 1022 may represent remote, local, fixed, and/or removable storage devices plus storage media for temporarily and/or more permanently including and storing computer-readable information for use by computer system 1000, including instructions executable by processing unit 1004 of computer system 1000.

Computer-readable storage media 1022 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 1000.

Machine-readable instructions executable by one or more processors or cores of processing unit 1004 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments, communications subsystem 1024 can include radio frequency (RF) transceiver components to access wireless voice and/or data networks (e.g., using cellular telephone technology, advanced data network technology, such as 4G, 4G, or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1040, and the like on behalf of one or more users who may use computer system 1000.

By way of example, communications subsystem 1024 may be configured to receive data feeds 1026 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 1024 may be configured to receive data in the form of continuous data streams. The continuous data streams may include event streams 1028 of real-time events and/or event updates 1040 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1040, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in FIG. 10 is intended as a non-limiting example. Many other configurations having more or fewer components than the system depicted in FIG. 10 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
prior to executing or storing at least a portion of a target cloud resource on a physical computing device:
determining a level of protection corresponding to a physical computing device that is available for executing or storing at least a portion of a target cloud resource;
determining whether the level of protection meets one or more protection criteria; and
responsive to determining that the level of protection meets the one or more protection criteria: initiating the executing or storing of at least the portion of the target cloud resource on the physical computing device;
wherein the method is performed by at least one device comprising a hardware processor.

2. The method of claim 1, further comprising:
identifying a plurality of candidate physical computing devices for executing or storing at least a portion of a second cloud resource;
determining a level of protection corresponding to each of the plurality of candidate physical computing devices;
based on the level of protection corresponding to each of the plurality of candidate physical computing devices: selecting a particular candidate physical computing device, from the plurality of candidate physical computing devices, for executing or storing at least the portion of the second cloud resource; and
initiating the executing or storing of at least the portion of the second cloud resource on the particular candidate physical computing device.

3. The method of claim 1, further comprising determining the one or more protection criteria based on a set of one or more characteristics corresponding to the target cloud resource.

4. The method of claim 1, wherein the level of protection comprises a level of physical protection that controls and/or monitors physical access to the physical computing device.

5. The method of claim 1, wherein determining whether the level of protection meets one or more protection criteria comprises determining at least one of:
determining whether a type of monitoring device specified by the one or more protection criteria is monitoring the physical computing device;
determining whether a type of monitoring device specified by the one or more protection criteria is monitoring a physical access path to the physical computing device; and
determining whether a type of physical access control specified by the one or more protection criteria is implemented for physical access to the physical computing device.

6. The method of claim 1, wherein the level of protection corresponding to the physical computing device is determined at least by querying a data center model that comprises at least one of:
a mapping of protection mechanisms to physical computing devices; or
a mapping of protection mechanisms to physical access paths leading to the physical computing devices.

7. The method of claim 1 wherein the level of protection is determined as a function of a software security status and/or a physical security status.

8. The method of claim 1, wherein:
the physical computing device is located within a particular physical environment, and
the level of protection is determined as a function of one or more of:
a current operation status of locks in the particular physical environment;
historical data corresponding to access to the particular physical environment;
planning data corresponding to planned access to the particular physical environment; or
a health status corresponding to physical protection mechanisms within the particular physical environment.

9. The method of claim 1, wherein determining the level of protection based on a qualitative and/or quantitative measure of one or more of: a software security, a physical security, and/or a combined security status corresponding to the physical computing device or a particular physical environment that includes the physical computing device.

10. The method of claim 1, further comprising:
determining a protection status for the target cloud resource based at least in part on the level of protection corresponding to a physical computing device; and
displaying protection dashboard comprising the protection status for the target cloud resource.

11. The method of claim 1, further comprising:
programmatically transferring the target cloud resource and/or a workload executed by the cloud resource based on a protection status for the target cloud resource.

12. One or more non-transitory computer-readable media comprising instructions that, when executed by one or more hardware processors, cause performance of operations comprising:
prior to executing or storing at least a portion of a target cloud resource on a physical computing device:
determining a level of protection corresponding to a physical computing device that is available for executing or storing at least a portion of a target cloud resource;
determining whether the level of protection meets one or more protection criteria; and
responsive to determining that the level of protection meets the one or more protection criteria: initiating the executing or storing of at least the portion of the target cloud resource on the physical computing device.

13. The one or more non-transitory computer-readable media of claim 12, wherein the operations further comprise:
identifying a plurality of candidate physical computing devices for executing or storing at least a portion of a second cloud resource;
determining a level of protection corresponding to each of the plurality of candidate physical computing devices;
based on the level of protection corresponding to each of the plurality of candidate physical computing devices: selecting a particular candidate physical computing device, from the plurality of candidate physical computing devices, for executing or storing at least the portion of the second cloud resource; and
initiating the executing or storing of at least the portion of the second cloud resource on the particular candidate physical computing device.

14. The one or more non-transitory computer-readable media of claim 12, wherein the operations further comprise: determining the one or more protection criteria based on a set of one or more characteristics corresponding to the target cloud resource.

15. The one or more non-transitory computer-readable media of claim 12, wherein the level of protection comprises a level of physical protection that controls and/or monitors physical access to the physical computing device.

16. The one or more non-transitory computer-readable media of claim 12, wherein determining whether the level of protection meets one or more protection criteria comprises determining at least one of:
determining whether a type of monitoring device specified by the one or more protection criteria is monitoring the physical computing device;
determining whether a type of monitoring device specified by the one or more protection criteria is monitoring a physical access path to the physical computing device; and
determining whether a type of physical access control specified by the one or more protection criteria is implemented for physical access to the physical computing device.

17. The one or more non-transitory computer-readable media of claim 12, wherein the level of protection corresponding to the physical computing device is determined at least by querying a data center model that comprises at least one of:
a mapping of protection mechanisms to physical computing devices; or
a mapping of protection mechanisms to physical access paths leading to the physical computing devices.

18. The one or more non-transitory computer-readable media of claim 12 wherein the level of protection is determined as a function of a software security status and/or a physical security status.

19. The one or more non-transitory computer-readable media of claim 12, wherein:
the physical computing device is located within a particular physical environment, and
the level of protection is determined as a function of one or more of:
a current operation status of locks in the particular physical environment;
historical data corresponding to access to the particular physical environment;
planning data corresponding to planned access to the particular physical environment; or
a health status corresponding to physical protection mechanisms within the particular physical environment.

20. The one or more non-transitory computer-readable media of claim 12, wherein determining the level of protection based on a qualitative and/or quantitative measure of one or more of: a software security, a physical security, and/or a combined security status corresponding to the physical computing device or a particular physical environment that includes the physical computing device.

21. The one or more non-transitory computer-readable media of claim 12, wherein the operations further comprise:
determining a protection status for the target cloud resource based at least in part on the level of protection corresponding to a physical computing device; and
displaying protection dashboard comprising the protection status for the target cloud resource.

22. The one or more non-transitory computer-readable media of claim 12, wherein the operations further comprise:
programmatically transferring the target cloud resource and/or a workload executed by the cloud resource based on a protection status for the target cloud resource.

23. A system comprising:
one or more hardware processors;
one or more non-transitory computer-readable media; and
program instructions stored on the one or more non-transitory computer-readable media that, when executed by the one or more hardware processors, cause the system to:
prior to executing or storing at least a portion of a target cloud resource on a physical computing device:
determining a level of protection corresponding to a physical computing device that is available for executing or storing at least a portion of a target cloud resource;
determining whether the level of protection meets one or more protection criteria; and
responsive to determining that the level of protection meets the one or more protection criteria: initiating the executing or storing of at least the portion of the target cloud resource on the physical computing device.
